(19) United States
(12) Patent Application Publication
(10) Pub. No.: US 2015/0222017 A1
(43) Pub. Date: Aug. 6, 2015

(54) ANTENNA DEVICE, NON-CONTACT POWER TRANSMISSION ANTENNA UNIT, AND ELECTRONIC APPARATUS

(71) Applicant: DEXERIALS CORPORATION, Tokyo (JP)

(72) Inventors: Tatsuo KUMURA, Tokyo (JP); Yusuke KUBO, Tokyo (JP); Hiroyuki RYOSON, Tokyo (JP)

(21) Appl. No.: 14/605,293

(22) Filed: Jan. 26, 2015

(30) Foreign Application Priority Data
Jan. 31, 2014 (JP) 2014-016435

(51) Int. Cl. H01Q 7/06; H02J 5/00

(52) U.S. Cl. CPC H01Q 7/06; H02J 5/005

(57) ABSTRACT

An antenna device according to the invention includes a spiral coil, a magnetic layer supporting the spiral coil and including a recess or a through hole for containing an extension from an inner periphery of the spiral coil, and a circuit board having a plurality of conducting patterns and being formed with a first terminal connecting the spiral coil to the conducting patterns and with a second terminal connecting the conducting patterns to an external circuit. The magnetic layer has at least a part of the circuit board inside. This invented antenna device is formed in a thinner size.

### CROSS REFERENCES TO RELATED APPLICATIONS

The present application claims priority to Japanese Priority Patent Application JP 2014-016435 filed in the Japan Patent Office on Jan. 31, 2014, the entire content of which is hereby incorporated by reference.

### BACKGROUND

1. Field of the Invention

This invention relates to an antenna device for noncontact power transmission and an electronic apparatus and, more particularly, to an antenna device including a spiral coil or coils for noncontact power supply and telecommunication, a magnetic layer, and a circuit board for noncontact power transmission and to an electronic apparatus having such an antenna device.

2. Description of Related Art

Plural RF (Radio Frequency) antennas such as, e.g., an antenna for telephone communications, an antenna for GPS (Global Positioning System), an antenna for wireless LAN (Local Area Network)/Bluetooth (Registered Trademark), and an RFID (Radio Frequency Identifier or Identification) are mounted on recent wireless communication devices. In addition, an antenna coil for power transmission is also mounted according to increased introduction of noncontact battery charge. As a power transmission method for a noncontact battery charge process, exemplified are such as, e.g., an electromagnetic induction method, a radio wave transmission method, and a magnetic resonance method. Each of these methods utilizes electromagnetic induction or magnetic resonance between a primary coil and a secondary coil, and the above-mentioned RFID also utilizes electromagnetic induction.

Those antennas not easily obtain targeted features when actually mounted on an electronic apparatus, even where designed to obtain the maximum features at a targeted frequency with such an antenna alone. This is because magnetic components near the antenna may interfere or couple, e.g., metal pieces located near the antenna to substantially reduce the inductance of the antenna coil and thereby to shift the resonance frequency. Such a substantial reduction of the inductance may impair receiving sensitivity. As a measure to solve those problems, magnetic shielding members may be inserted among the antenna coil and the metal pieces located near the coil, thereby gathering magnetic flux generated from the antenna coil in the magnetic shielding members, and thereby reducing interference due to the metal pieces. Where such magnetic shielding members are disposed near the antenna coil, the inductance of the antenna coil and the coupling coefficient indicating goodness of magnetic coupling can be increased.

In accordance with tendencies to render electronic apparatuses be smaller and have more functions, where plural antennas are mounted on an electronic device such as, e.g., a mobile phone device, a space assigned for mounting such antennas is very small, so that designing each antenna in a small size is demanded. It is also demanded to provide a connection terminal at the antenna unit for connecting an external circuit from a relation to a connecting method to the external circuit.

In Japanese Patent Application Publication (A1) No. 2013-21,902, an antenna device, which is set forth as “a noncontact transmission device,” is disclosed with a nested formation of a noncontact power supply coil and a noncontact communication coil as shown in FIG. 9, for making smaller an area assigned for the coils. In this disclosure, a coil is made with a flexible board, and a connection terminal is provided at an end of this board. Because the noncontact communication coil 120 and the noncontact power supply coil 130 are mounted on a magnetic body 110, and because no space for containing an extension portion from an inner periphery of the coils is formed, the antenna device cannot reduce its thickness enough.

In Japanese Patent Publication (B2) No. 4,572,953, an antenna device, set forth as a coil unit in the publication, is disclosed in which a space is formed at a part of a circuit board 220 having a connection terminal connecting to the exterior as shown in FIG. 10, and a coil 210 is embedded in the space while the magnetic body 240 is pasted via a spacer 230. In this example, however, though the coil 210 is contained in the circuit board 220, the antenna device cannot be made thin because the spacer is placed as an extra.

In Japanese Patent Publication (B2) No. 5,077,476, disclosed are a noncontact charge module pulling out a wire of an inner peripheral edge of a noncontact charge coil to an exterior through a slit formed in a magnetic shielding material, and a mobile phone having the noncontact charge module. However, what is formed at the shielding material is a completely opened “slit,” and there is no disclosure on a terminal used for connecting the exterior circuit to the wire pulled out via the slit.

In Japanese Patent Application Publication (Al) No. 2010-50,345, a plane air-core coil is arrange on one side of a printed circuit board, and a coil element provided with a sheet shaped electromagnetic wave shielding member on the other side of the printed circuit board is disclosed. A recess containing a wire portion extended from an inner peripheral edge of the coil is formed in the printed circuit board. However, the recess is formed only in the printed circuit board, and the electromagnetic wave shielding member is provided as a part other than the board, so that the entire thickness is made thicker for a portion of the board.

It is an object of the invention to provide an antenna device having an antenna or plural antennas in a thinner size.

### SUMMARY

To solve the above problems, an antenna device according to a first aspect of the invention comprises a spiral coil, a magnetic layer supporting the spiral coil and including a recess or a through hole for containing an extension from an inner periphery of the spiral coil, and a circuit board having a plurality of conducting patterns and being formed with a first terminal connecting the spiral coil to the conducting patterns and with a second terminal connecting the conducting patterns to an external circuit. The magnetic layer has at least a part of the circuit board inside.

In accordance with a second aspect of the invention, the antenna device according to the first aspect has the second terminal fabricated to be coupled to the external circuit via a connector or anisotropic conducting particles.

In accordance with a third aspect of the invention, the antenna device according to the first aspect has the spiral coil and the magnetic layer connected with a magnetic resin layer including a magnetic powder.

In accordance with a fourth aspect of the invention, the antenna device according to the first aspect has the magnetic layer made of any of a magnetic resin layer including a magnetic powder, a ferrite layer, and a pressurized powder molded layer, or a hybrid magnetic layer in combination of those layers.

In accordance with a fifth aspect of the invention, the antenna device according to the first aspect has the circuit board formed with a sensing element.

In accordance with a sixth aspect of the invention, the antenna device according to the first aspect has the circuit board made of a flexible board.

In accordance with an eighth aspect of the invention, the antenna device according to the first aspect has the spiral coil provided at two or more locations.

In accordance with a ninth aspect of the invention, the antenna device according to the first aspect has the spiral coils with two extensions, and has the recess or the through hole provided at two positions in the magnetic layer corresponding to the extensions, respectively.

In accordance with a tenth aspect of the invention, an electronic apparatus includes the antenna device according to the first aspect, and the external circuit for performing a function of the electronic apparatus.

According to the antenna device of the invention, the antenna device can be made in a thinner size by containing, in the magnetic layer for supporting the spiral coil or coils, the extension from the inner periphery of the spiral coil and a part of the circuit board.

These and other objects, features, aspects and advantages of the present invention will become apparent to those skilled in the art from the following detailed description, which, taken in conjunction with the annexed drawings, discloses a preferred embodiment of the present invention.

Additional features and advantages are described herein, and will be apparent from the following Detailed Description and the figures.

### BRIEF DESCRIPTION OF THE FIGURES

Referring now to the attached drawings which form a part of this original disclosure:

FIG. 1 is a plan view showing an antenna device according to a first embodiment of the invention;

FIG. 2 is a perspective view showing the antenna device shown in FIG. 1;

FIG. 3 is an exploded perspective view showing the antenna device shown in FIG. 1;

FIG. 4 is a plan view showing an antenna device according to a second embodiment of the invention;

FIG. 5 is a perspective view showing the antenna device shown in FIG. 4;

FIG. 6 is a plan view showing an antenna device according to a third embodiment of the invention;

FIG. 7 is a perspective view showing the antenna device shown in FIG. 6;

FIG. 8 is a perspective view showing an electronic apparatus and an antenna device according to the invention

FIG. 9 is a plan view showing a prior art antenna device; and

FIG. 10 is an exploded perspective view showing another prior art antenna device.

### DETAILED DESCRIPTION

Selected embodiments of the present invention will now be explained with reference to the drawings. It will be apparent to those skilled in the art from this disclosure that the following descriptions of the embodiments of the invention are provided for illustration only and not for the purpose of limiting the invention as defined by the appended claims and their equivalents.

### First Embodiment

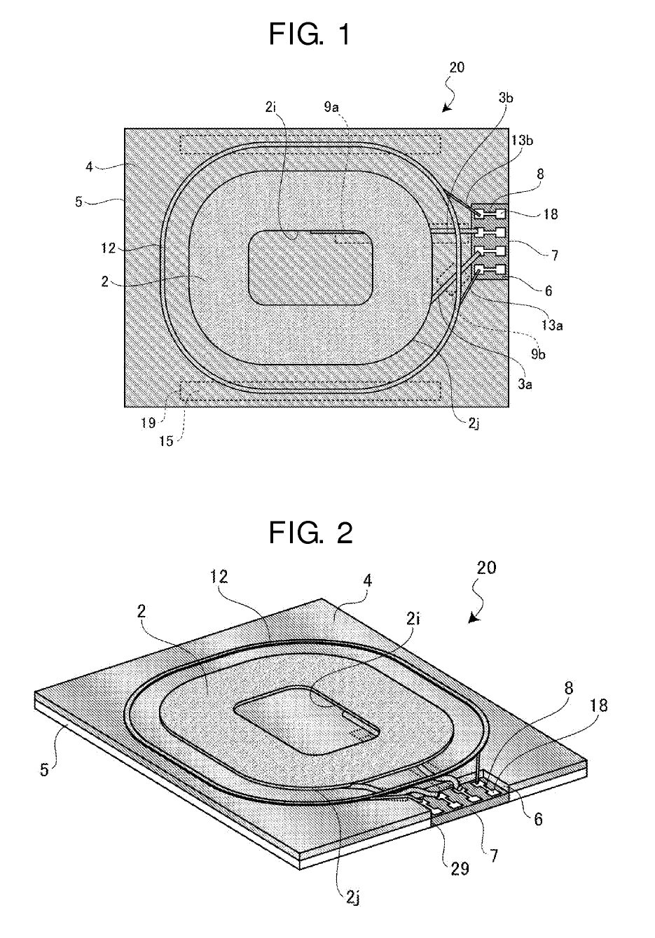

Referring initially to FIGS. 1, 2, an antenna device according to a first embodiment is illustrated. As shown in FIGS. 1, 2, an antenna device 20 includes spiral coils 2, 12 formed in winding a wire in a spiral shape, respectively, magnetic layers 5, 15, an adhesive layer 4, and a circuit board 7. In FIG. 1, the adhesive layer 4 and the magnetic layer 5 are illustrated as transparent layers for rendering a structure of the antenna device readily understandable. The spiral coils 2, 12 are illustrated as each having a large single turn for the purpose of brevity. The spiral coil 2 is used for noncontact power supply, whereas the spiral coil 12 is used for noncontact communications. Such a spiral coil may be formed from a method well known to those skilled in the art, such as, e.g., a method by winding a fine wire or line in a spiral shape or by fabricating a conducting layer on an insulator or semi-insulation board with a photolithographic method.

The magnetic layer 5 is formed with cutoff portions 9a, 9b, 19, 29. The cutoff portion 9a is a portion containing an extension 3b extending from an inner periphery 2i of the spiral coil 2. The cutoff portion 9b is a portion containing an extension 3a extending from an outer periphery 2j of the spiral coil 2. This cutoff portion 9b may not be formed. The cutoff portion 19 is a portion containing the magnetic layer 15, and the cutoff portion 29 is a portion containing the circuit board 7.

A reason why the cutoff portion 9a is formed for the extension 3b of the spiral coil 2 is that the wire size is needed to be large to reduce the resistance of the spiral coil 2 where the spiral coil 2 is used for noncontact power supply as power transmission and that the total thickness of the antenna device 20 is suppressed by passing the extension 3b through the cutoff portion 9a of the magnetic layer 5. Similarly, a reason why the cutoff portion 9b is formed for the extension 3a of the spiral coil 2 is that the total thickness of the antenna device 20 is suppressed by passing the extension 3a through the cutoff portion 9b beneath the spiral coil 12.

The cutoff portion 9a is preferably extended to a point beyond an intersecting area of the two spiral coils 2, 12 to suppress the total thickness even at a portion where the extension 3b of the spiral coil 2 intersects the spiral coil 12.

Those cutoff portions 9a, 9b, 19, 29 are not required to be formed as through holes or openings, and can be formed as grooves formed as carved into the magnetic layer 5 with remaining their bottoms or namely recesses. The hybrid board made by setting the circuit board 7 and the magnetic layer 15 to the magnetic layer 5 is connected to the spiral coils 2, 12 via the adhesive layer 4.

The circuit board 7 is formed with first terminals 8 connected to the extensions 3a, 3b extended from the spiral coil 2 and to the extensions 13a, 13b extended from the spiral coil 12 and with second terminals 18 connected to an external circuit, and circuit patterns electrically connected between the first and second terminals 8, 18.

The extension 3b extended from the inner periphery 2i of the spiral coil 2 is connected to one of the first terminals 8 formed on the circuit board 7 via the cutoff portion 9a using a solder or the like. The extension 3a extended from the outer periphery 2j of the spiral coil 2 is connected to one of the first terminals 8 formed on the circuit board 7 via the cutoff portion 9b using a solder or the like. The extensions 13a, 13b of the spiral coil 12 are directly connected to the first terminals 8 formed on the circuit board 7 with a solder or the like. A secondary circuit of the noncontact charge circuit is structured by connecting a circuit such as, e.g., a rectification circuit not shown with the second terminals 18 connected to the first terminals 8, respectively.

Employed as the circuit board 7 is what is formed with circuit patterns made of a conducting material on a single side or double sides of a dielectric board, or namely, a rigid board, a flexible board, and a rigid and flexible board as a hybrid body of those boards. The circuit board 7 can be a multilayer board having conductive patterns connected through conducting plug at via holes.

The magnetic layers 5, 15 may be formed from metal magnetic bodies such as, e.g., Fe based materials, Fe-Si based materials, sendusts, permalloys, and amorphous metal materials, MnZn based ferrites, NiZn ferrites, magnetic resin materials made from adding a resin or resins as binders to magnetic particles made of one or more of the above magnetic materials, and pressurized powder molded materials made upon adding a binder in a small amount to magnetic particles. Those magnetic bodies can be used individually or in a mixed way.

The magnetic layers 5, 15 are formed as a hybrid or multiplayer structure in combination of the plural magnetic layers of the above materials. In the example shown in FIG. 1, the magnetic layer 5 is made of a magnetic resin material, and the magnetic layer 15 is made of a NiZn based ferrite. The magnetic bodies thus can be formed in appropriate manners in accordance with frequency to be used.

Line sizes and line structures of the spiral coils 2, 12 are decided according to usage and frequency to be used. For example, where the spiral coil 2 is used for a frequency of around 100 to 200 kHz with a charge output capacity of around 5 W as for noncontact power supply, it is preferable to use a single line made of Cu or an alloy having Cu as a main component in a size of 0.05 to 0.15 mm diameter.

In any cases, for the spiral coils, parallel wires or braided wires in which plural fine lines finer than the above single line are bundled can be used to reduce a skin effect of the conducting line. Such a spiral coil can be formed with an alpha winding structure of a single layer or double layers in use of a rectangular line or a flat line having a thin thickness.

On the other hand, the adhesive layer 4 is used for adhering the spiral coils 2, 12 with a surface on one side of the hybrid board made of the magnetic layers 5, 15 and the circuit board 7. The adhesive layer 4 can be formed of any materials having adhesive property.

The adhesive layer 4 can be made from a double side adhesive tape having adhesive layers formed on double sides of a thin sheet such as, e.g., PET (polyethylene terephthalate), and further can be made of a magnetic resin sheet formed from a resin mixed with a magnetic powder or powders. When the magnetic resin sheet is used, the magnetic shielding property can be improved because the portion of the adhesive layers 4 works as a magnetic body. In this case, if the magnetic resin sheet is produced with a thicker thickness, and if the spiral coils 2, 12 are embedded, the adhesive property and magnetic shielding property can be improved. It is also expected to gain an effect to easily escape the heat generated at the spiral coils 2, 12.

In FIGS. 1, 2, an opening 6 is formed in the adhesive layer 4 so as not to disturb the connection between the extensions 3a, 3b, 13a, 13b and the first terminals 8 and the connection between the second terminals 18 and the external circuit or board at subsequent processing steps.

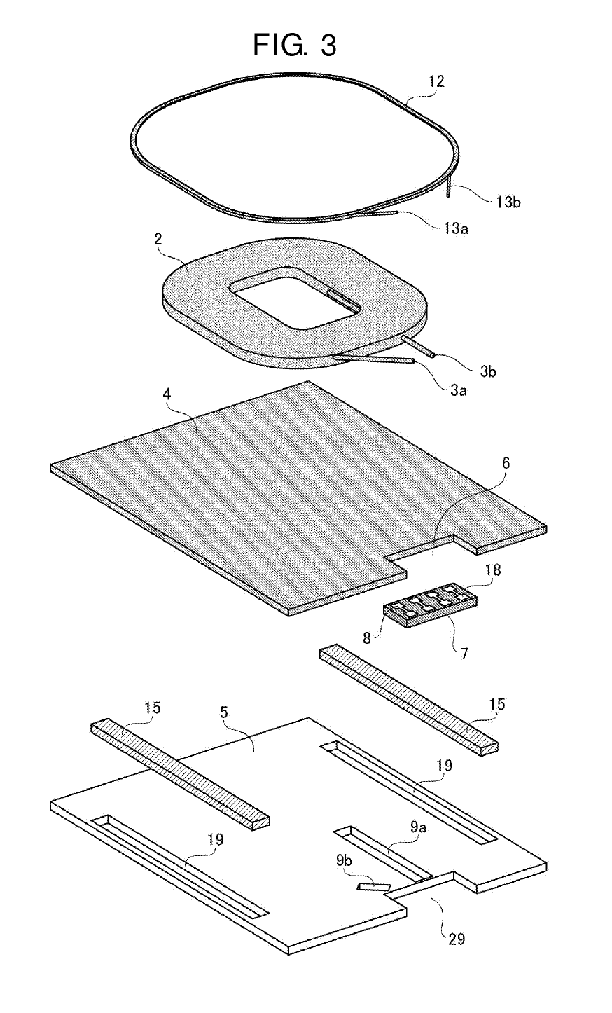

Referring to FIG. 3, a method for producing the antenna device according to this embodiment as shown in FIGS. 1, 2, is described.

First, a sheet for the magnetic layer 5 is prepared. This sheet makes the magnetic flux convergent around the spiral coils 2, 12, and the sheet having a larger size than the size of the spiral coils 2, 12 is selected generally. According to the example shown in FIGS. 1, 2, a part of the magnetic layer 5 is replaced with the magnetic layer 15 as a magnetic layer supporting a part of the spiral coil 12. In the example shown in FIGS. 1, 2, it is structured in supposing that the spiral coil 2 is used for noncontact power supply to make communications with around 100 kHz and that the spiral coil 12 is used for noncontact communication of 13.56 MHz. The structure uses magnetic materials suitable for respective communications, and thus, this antenna device can use plural magnetic layers in a combining manner.

The magnetic layer 5 is formed with the cutoff portion 9a for passing the extension 3b extending from the inner periphery of the spiral coil 2 and with the cutoff portion 9b for passing, below the spiral coil 12, the extension 3a extending from the outer periphery. The magnetic layer 5 is formed also with the cutoff portion 19 for installing the magnetic layer 15 and with the cutoff portion 29 for installing the circuit board 7.

Subsequently, the magnetic layer 15 and the circuit board 7 are inserted into the cutoff portions 19, 29, respectively. Then, the adhesive layer 4 is pasted to one side of the hybrid body of the magnetic layer 5 and the circuit board 7. The adhesive layer 4 is formed with the opening 6, which is provided to allow connections between the extensions 3a, 3b extending from the spiral coil 2 and the conducting patterns formed on the circuit board 7 at a following process done with such as, e.g, a solder.

Finally, the spiral coils 2, 12 are pasted to predetermined positions of the adhesive layer 4 sequentially and pressed thereto. The extensions 3a, 3b, 13a, 13b are soldered to prescribed first terminals 8 formed on the circuit board 7 to complete the antenna device 20. Where a magnetic resin layer is used as the adhesive layer 4, a heating treatment may be performed at the same time as pressing to solidify the resin and secure the connection.

When the antenna device is used, a protection sheet adhesive may be pasted to a single side or double sides of the setting surface and the non-setting surface of the spiral coils 2, 12 of the antenna device.

As described above, according to the first embodiment of the invention, the antenna device 20 has the layered structure made of the magnetic layer 5, the adhesive layer 4, and the spiral coils 2, 12. Because the magnetic layer 5 is formed with the cutoff portions 9a, 9b, the extension 3b extending from the inner periphery of the spiral coil 2 can be extended through the cutoff portion 9a, so that the total thickness can be reduced to the thickness formed from the size of the spiral coil 2 and the summation of the magnetic layer 5 and the adhesive layer 4, or the total thickness can be reduced to twice of the size of the spiral coil 2 and the adhesive layer 4. That is, the antenna device can be made in a thinner size. The antenna device can improve connection property for external circuits.

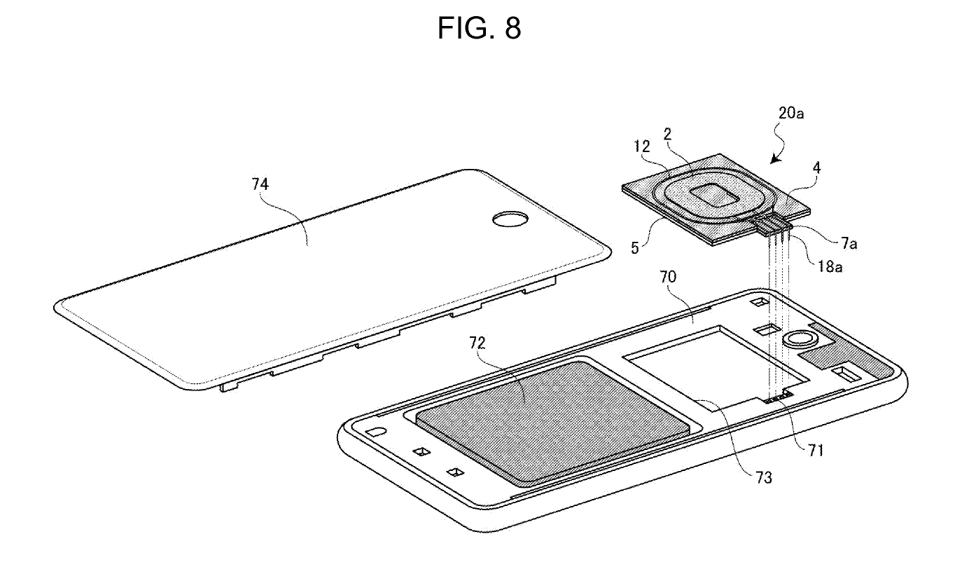

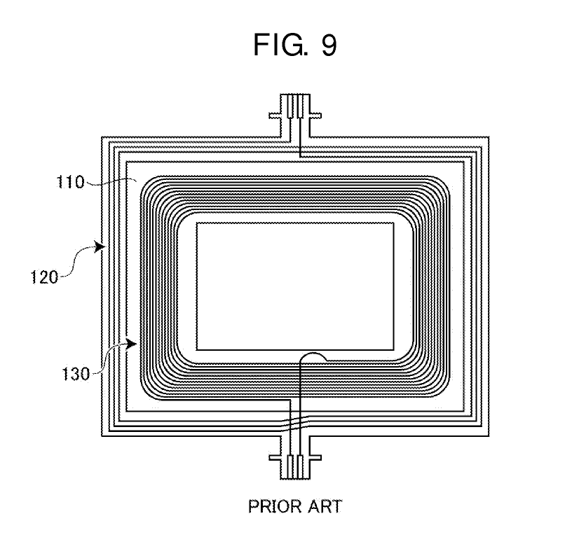

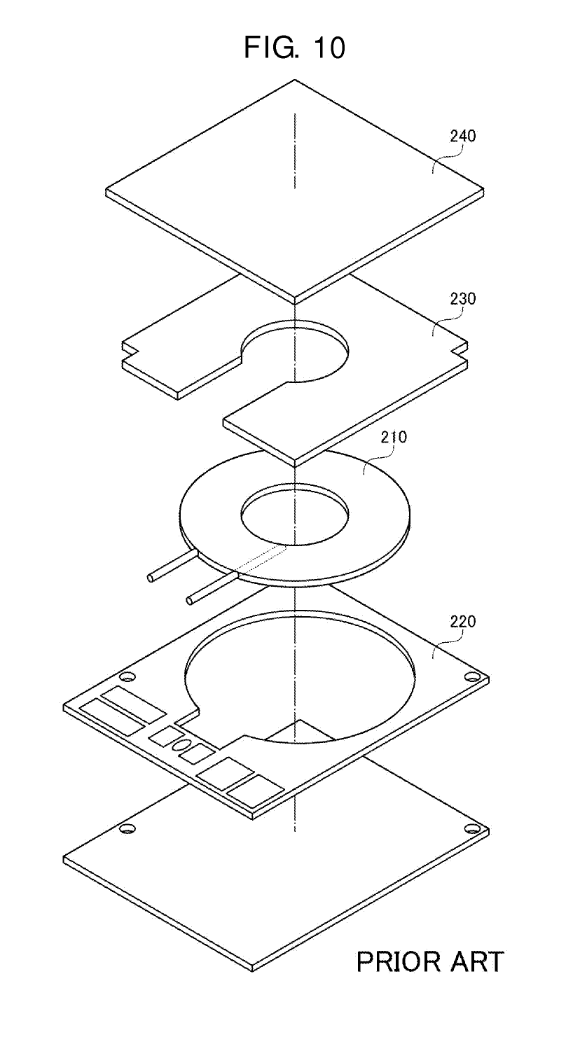

FIG. 8 shows an antenna device 20a and an electronic apparatus 70 coupled to the antenna device 20a. The antenna device 20a has a structure similar to that of the antenna device 20 mentioned above, including spiral coils 2, 12 formed in winding a wire in a spiral shape, respectively, a magnetic layer 5, an adhesive layer 4, and a circuit board 7a. The spiral coil 2 has an extension, not shown, extending from the inner periphery of the spiral coil and passing through a cutoff portion, not shown. The circuit board 7a has conducting patterns connected to pins 18a extending from a back side of the circuit board 7a. The conducting patterns are also connected to respective portions of the spiral coils 2, 12 in a manner similar to the antenna device 20.

The electronic apparatus 70 operates as a mobile phone and has a battery package 72 and an antenna device slot 73 to place the antenna device 20a therein. The antenna device 20a is connected to the electronic apparatus 70 via a connector 71 by inserting the pins 18a of the antenna device 20a in holes formed in the connector 71. The antenna device 20a can be placed into the antenna device slot 73 when a back cover 74 is removed from the body of the electronic apparatus 70.

In this embodiment, the electronic apparatus 70 is the mobile phone, but is applicable to other type apparatuses such as, e.g., laptop computers, and tablet devices. The connector can be made of other types such as, e.g., contact types or the like.

### Second Embodiment

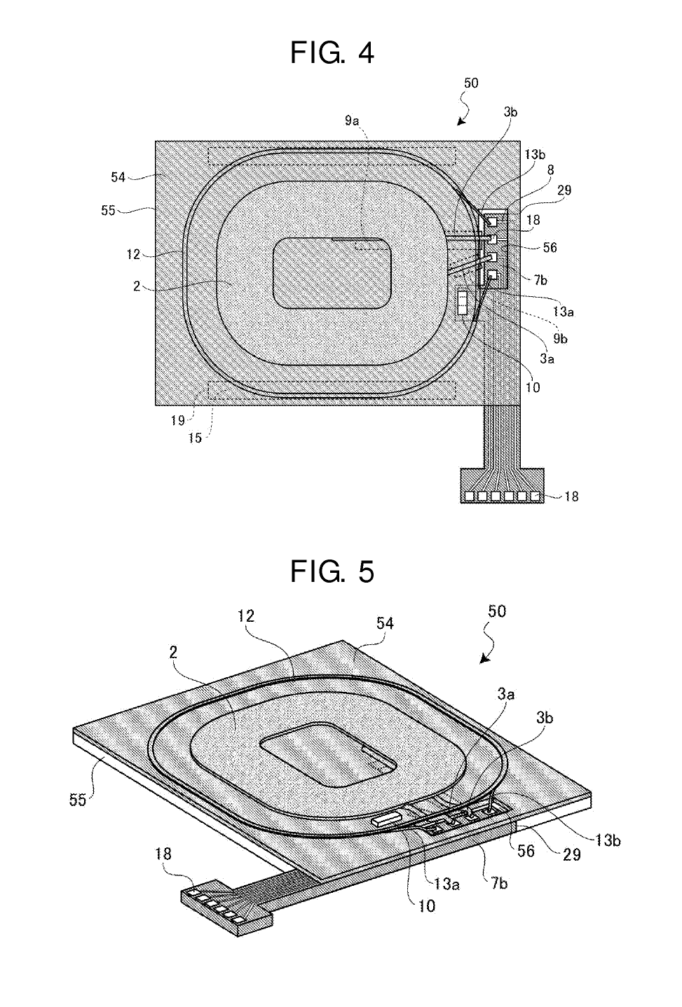

FIGS. 4, 5 show a structure of an antenna device according to the second embodiment of the invention. For illustration purpose, an adhesive layer 54 and a magnetic layer 55 are shown as transparent layers in FIG. 4. Elements having the same structure as those shown in the first embodiment are illustrated with the same reference numbers, and a description is omitted for the sake of brevity.

As shown in FIGS. 4, 5, the antenna device 50 according to the second embodiment includes a flexible cable 7b as a circuit board. The flexible cable 7b has a cable length longer extending outward from the magnetic layer 55 in order to make easy the connections to an external circuit or element, and can be used upon being folded.

In this example, a sensing device 10 is mounted on the flexible cable 7b. The sensing device 10 can be formed in any form such as, e.g., chip type for mounting, wiring type, and it is preferable to choose a low profile chip element in view of property for suppressing a thickness of the antenna device and mountability. The sensing device 10 is mounted on the flexible cable 7b with a solder or the like.

The sensing device 10 may be a temperature sensing element such as, e.g., a thermistor for monitoring temperature increase and decrease of the antenna device 50, and a hole element for monitoring the magnetic field intense. Those elements can be provided in a plural number or in a combination. The sensing device 10 may be formed as a structure covered with the adhesive layer 54, or may be formed as a structure not contacting the adhesive layer 54 upon forming an opening, not shown, in the adhesive layer 54.

In the embodiment shown in FIGS. 4, 5, the opening 56 is formed in the adhesive layer 54 at a part on the flexible cable 7b. This is provided to connect the extensions 3a, 3b extending from the spiral coil 2 and the extensions 13a, 13b extending from the spiral coil 12 with the first terminals 8 formed on the flexible cable 7b in use of a solder or the like.

With this second embodiment, similarly to the first embodiment described above, the extension 3b extending from the spiral coil 2 is connected to one of the first terminals 8 formed on the flexible cable 7b with the solder or the like via the cutoff portion 9a. The cutoff portion 9b is formed at the intersection between the extension 3a extending from the outer periphery of the spiral coil 2 and the spiral coil 12, and the extension 3a is connected to one of the first terminals 8 formed on the flexible cable 7b with the solder or the like after passing through the cutoff portion 9b. The cutoff portion 9b may not be provided.

As described above, according to the second embodiment, the antenna device 50 has the accumulated structure made of the magnetic layers 15, 55, the adhesive layer 54, and the spiral coils 2, 12. Because the cutoff portion 9a is formed at the magnetic layer 55, the extension 3b extending from the inner periphery of the spiral coil 2 can be extended outward via the cutoff portion 9a. The antenna unit 50 therefore can suppress the total thickness in the summation of the size of the spiral coil 2, the adhesive layer 54, and the magnetic layer 55, or namely, the twice of the size of the spiral coil 2 and the adhesive layer 54. That is, the antenna unit 50 can be built in a thinner size, and can improve the property for connections with external circuits.

### Third Embodiment

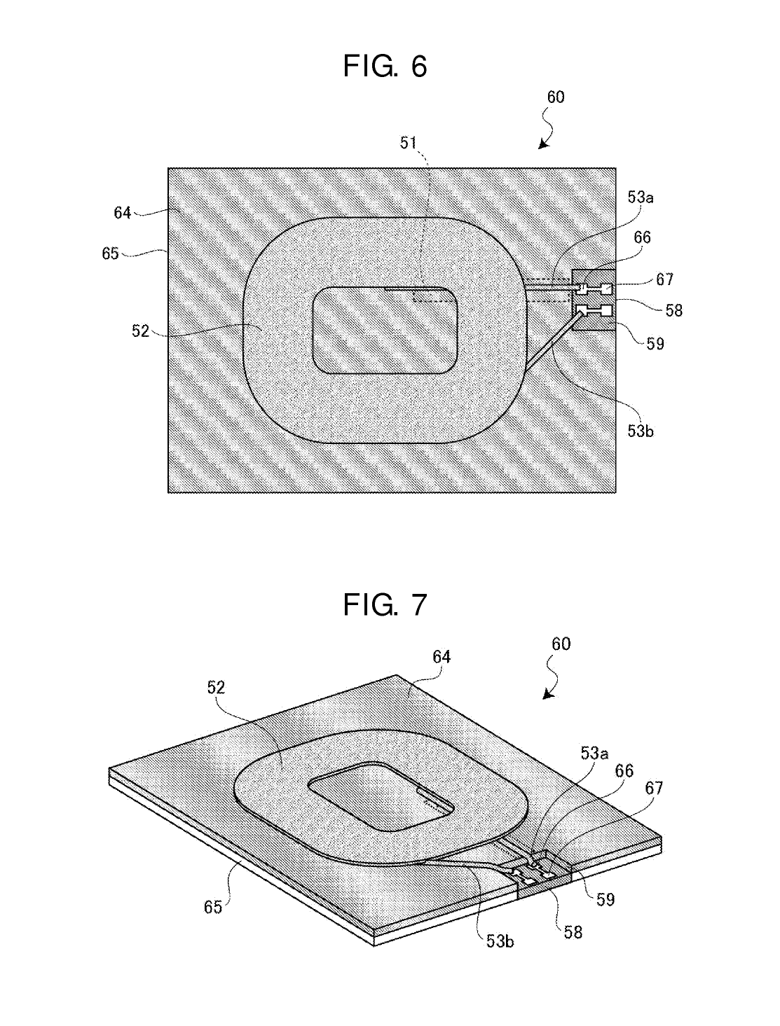

FIGS. 6, 7 show an antenna device according to the third embodiment of the invention. For illustration purpose, an adhesive layer 64 and a magnetic layer 65 are shown as transparent layers in FIG. 6. As shown in FIGS. 6, 7, an antenna device 60 includes a spiral coil 52 formed by winding a conducting wire in a spiral shape, the magnetic layer 65, the adhesive layer 64, and a circuit board 58. In FIGS. 6, 7, the spiral coil 52 is illustrated as a large single turn coil for the sake of brevity. In this embodiment, the spiral coil 52 is used for noncontact power supply.

A cutoff portion 51 is formed at the magnetic layer 65. The cutoff portion 51 contains an extension 53a extending from an inner periphery of the spiral coil 52. The reason why the cutoff portion 51 is provided is that the line size of the spiral coil 52 is necessarily large to reduce the resistance of the coil where the spiral coil 52 is used for noncontact power supply for power transmission and that the antenna device 60 has a reduced total thickness by passing the extension 53a through the cutoff portion 51 of the magnetic layer 65. The cutoff portion 51 is not required to be a penetrating hole or an opening, and can be formed as a craved groove having a remaining part of the magnetic layer 65 or namely as a recess. A hybrid board produced from the magnetic layer 65 setting with the circuit board 58 is connected to the spiral coil 52 via the adhesive layer 64. The cutoff portion 51 provided at the magnetic layer 65 may be formed at the adhesive layer 64.

The circuit board 58 is formed with first terminals 66 connected to the extensions 53a, 53b extending from the spiral coil 52, second terminals 67 connected to an external circuit, and circuit patterns electrically connecting the terminals 66, 67 with one another. The extension 53a extending from the inner periphery of the spiral coil 52 is connected to one of the first terminals 66 formed on the circuit board 58 via the cutoff portion 51 with a solder or the like. The extension 53b extending from the outer periphery of the spiral coil 52 is connected to one of the first terminals 66 with a solder or the like. As the circuit board 58, employed is what is formed with circuit patterns made of a conducting material on a single side or double sides of a dielectric board, or namely, a rigid board, a flexible board, and a rigid and flexible board as a hybrid body of those boards. The magnetic layer 65 may be formed of metal magnetic bodies, magnetic resin materials, and pressurized powder molded materials, which are the same types described in the first embodiment above.

Line sizes and line structures of the spiral coil 52 are decided according to usage and frequency to be used. For example, where the spiral coil 52 is used for a frequency of around 100 to 200 kHz with a charge output capacity of around 5 W as for noncontact power supply, it is preferable to use a single line, a parallel line, and a woven line, which are made of Cu or an alloy having Cu as a main component in a size of 0.15 to 0.45 mm diameter.

The adhesive layer 64 is used for jointing the spiral coil 52 with one side surface of the hybrid board made of the magnetic layer 65 and the circuit board 58, and can be in any form as far as having a proper adhesive property. These features are substantially the same as those described in the first embodiment.

As described above, according to the third embodiment of the invention, the antenna device 60 has the accumulated structure made of the magnetic layer 65, the adhesive layer 64, and the spiral coil 52. Because the cutoff portion 51 is formed at the magnetic layer 65, the extension 53a extending from the inner periphery of the spiral coil 52 can be extended outward via the cutoff portion 51. The antenna unit 60 therefore can suppress the total thickness in the summation of the size of the spiral coil 52, the adhesive layer 64, and the magnetic layer 65, or namely, the twice of the size of the spiral coil 52 and the adhesive layer 64. That is, the antenna unit 50 can be built in a thinner size, and can improve the property for connections with external circuits.

As described above, the antenna device according to any one of the first to third embodiments can reduce the thickness thereof by rendering the magnetic layer supporting the spiral coil or coils contain the extension extending from the inner periphery of the spiral coil and the circuit board.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An antenna device comprising:
a spiral coil;
a magnetic layer supporting the spiral coil, the magnetic layer including a recess or a through hole for containing an extension from an inner periphery of the spiral coil; and
a circuit board having a plurality of conducting patterns and being formed with a first terminal connecting the spiral coil to the conducting patterns and with a second terminal connecting the conducting patterns to an external circuit,
wherein the magnetic layer has at least a part of the circuit board inside.

2. The antenna device according to claim 1, wherein the second terminal is fabricated to be coupled to the external circuit via a connector or anisotropic conducting particles.

3. The antenna device according to claim 1, wherein the spiral coil and the magnetic layer are connected with a magnetic resin layer including a magnetic powder.

4. The antenna device according to claim 1, wherein the magnetic layer is made of any of a magnetic resin layer including a magnetic powder, a ferrite layer, and a pressurized powder molded layer, or a hybrid magnetic layer in combination of those layers.

5. The antenna device according to claim 1, wherein the circuit board is formed with a sensing element.

6. The antenna device according to claim 1, wherein the circuit board is made of a flexible board.

7. The antenna device according to claim 1, wherein the spiral coil is provided at two or more locations.

8. The antenna device according to claim 1, wherein the spiral coil provides two extensions, and wherein the recess or the through hole is provided at two positions in the magnetic layer corresponding to the extensions, respectively.

9. An electronic apparatus comprising:
the antenna device according to claim 1; and
the external circuit for performing a function of the electronic apparatus.
